(19) United States
(12) Patent Application Publication
(10) Pub. No.: US 2007/0094090 A1
(43) Pub. Date: Apr. 26, 2007

(54) Customized food preparation apparatus and method

(76) Inventors: Robert A. Jenkins, Chesterfield, MO (US); Brian S. Cross, St. Louis, MO (US)

Correspondence Address: SENNIGER POWERS, ONE METROPOLITAN SQUARE, 16TH FLOOR, ST LOUIS, MO, 63102, US

(21) Appl. No.: 11/256,750

(22) Filed: Oct. 24, 2005

(51) Int. Cl. G06Q 30/00

(52) U.S. Cl. 705/26; 705/27

(57) ABSTRACT

An improved method of preparing and selling an article of food from a retail establishment is disclosed. The method includes receiving an order from a customer where the order identifies ingredients and a quantity for the ingredients. The order also includes a preparation instruction for at least one of the ingredients. The quantity of each of the ingredients is gathered as a function of the order. The ingredients are prepared at the retail establishment as a function of the preparation instruction to provide a prepared food article. The prepared food article is packaged for available delivery to the customer. The method can also include consulting a list of potential ingredients corresponding to a diet plan and gathering the ingredients as a function of the order and the list. A nutritional value may be calculated for the prepared food article and communicated to the customer. The order may be received over an internet connection. The customer may specify particular ingredients as a function of the brand of the ingredients or of a growth or storage condition of the ingredients. An apparatus for enabling a retail customer to make a payment for a purchase from a third party using a financial card through an internet connection is also disclosed. Other apparatus and methods are also disclosed.

### BACKGROUND OF THE INVENTION

Recipes for various foods are often personal to the consumer. What one person may like, another person may find objectionable. And while it might be nice to prepare all meals from scratch according to one's sense of taste, it is often difficult to find time for such preparations.

At least one food chain allows customers to set up an appointment when the customer will have access to a kitchen area and pre-measured ingredients according to one or more predetermined recipes. The customer then prepares each of the dishes described by the recipes and takes them home in separate packages to be cooked as needed. However, persons with busy schedules may not have time to prepare their own meals or may not be able to make or keep an appointment. Other persons may not like the recipes that are available in the kitchen area.

Some grocers have offered shopping on-line. While such internet shopping can provide a measure of convenience over walking through the aisles of a grocery store to make purchases, it fails to provide custom preparation of selected ingredients.

As a result of the aforesaid problems, customers often content themselves by heating frozen food preparations or simply eating out at a restaurant or ordering in from a restaurant. Customers thus miss out on a freshly cooked meal where the customer controls the ingredients.

Further, with the common usage of the internet, customers often make purchases over the internet with a financial card (typically a debit card, credit card, stored value card or similar card) by providing the card number to the internet vendor. The vendor then contacts the card issuer to obtain authorization for the purchase and to receive compensation for the purchase. Food products can be purchased in this manner. A problem is that the internet vendor may not be honest and may charge other transactions to the unwitting customer's card. Even with an honest vendor, records of the transaction may include the card number and may be discovered by a computer hacker or other person who happens upon the computer records some time later. Such security risks can create a particular concern when dealing with a relatively unknown internet vendor.

### SUMMARY OF THE INVENTION

Among the objects of the present invention are to provide an improved apparatus and method for preparing and selling an article of food, to provide an improved apparatus for enabling a customer to make a payment using a financial card through an internet connection, to provide an improved apparatus and method which allow the customer to specify ingredients and a preparation instruction for the ingredients, and to provide an improved apparatus and method which are convenient for the customer to use.

In one embodiment, the invention comprises a method of preparing and selling an article of food from a retail establishment. The retail establishment has an inventory of ingredients in prepackaged amounts. The method includes receiving an order from a customer where the order identifies a plurality of ingredients and a quantity for the ingredients. The identified quantity for at least one of the ingredients is independent of the prepackaged amount. The order contains a preparation instruction for at least one of the ingredients. The method includes gathering the quantity of each of the ingredients from the inventory of the retail establishment as a function of the order and preparing the ingredients at the retail establishment as a function of the preparation instruction to provide a prepared food article. The prepared food article is packaged for available delivery to the customer. The method may include a calculation of the nutritional value for the prepared food article which value is communicated to the customer. The method may also include allowing the customer to specify the ingredients as a function of the brand of the ingredients or of a growth or storage condition of the ingredients.

In another embodiment, the invention comprises a method of preparing and selling an article of food from a retail establishment. The method includes receiving an order from a retail customer over an internet connection. The order identifies a plurality of ingredients and a quantity for the ingredients. The order also contains a preparation instruction. The method includes gathering the quantity of each of the ingredients as a function of the order and preparing the ingredients at the retail establishment as a function of the preparation instruction to provide a prepared food article. The prepared food article is packaged for delivery to the retail customer. The method may include identifying a food coupon corresponding to an ingredient and calculating a cost of the ingredients required for the order. The ingredients can be gathered to reduce cost as a function of a price of the ingredients discounted by the food coupon.

In yet another embodiment, the invention comprises an apparatus for enabling a retail customer to make a payment for a purchase from a third party using a financial card through an internet connection. The purchase is charged against an account held by the retail customer with a financial institution. The apparatus includes a magnetic card reader located in the retail customer's home, office or personal space for enabling the retail customer to swipe the financial card through the magnetic card reader. The magnetic card reader is adapted to read customer information upon the occurrence of the card being swiped. The apparatus includes a circuit coupled to the magnetic card reader and the internet connection for transmitting the customer information to the financial institution over the internet. Data corresponding to the third party and a monetary amount corresponding to the purchase are also transmitted to the financial institution over the internet. The monetary amount corresponding to the purchase may be charged against the account.

Other objects and features will be in part apparent and in part pointed out hereinafter.

### BRIEF DESCRIPTION OF THE DRAWINGS

FIG. 1 shows a computer display for enabling a customer to login and use an embodiment of the present invention.

FIG. 2 shows a computer display for entering a new recipe, accessing previously stored recipes or meal plans, checking available coupons and shopping generally with an embodiment of the present invention.

FIG. 3 shows a computer display for entering the ingredients, amounts and preparation instructions for a new recipe, and cuisine options for the recipe, as well as controlling the source of the ingredients, accessing previously stored recipes or meal plans, checking available coupons, and shopping generally with an embodiment of the present invention.

FIG. 4 shows a computer display for shopping based on previously stored recipes as well as selecting cuisine options for the recipe, controlling the source of the ingredients, accessing previously stored meal plans, checking available coupons, and shopping generally with an embodiment of the present invention.

FIG. 5 shows a computer display for accessing previously stored meal plans, creating new meal plans, and entering cuisine options for such meal plans, as well as controlling the source of the ingredients, accessing previously stored recipes, checking available coupons, and shopping generally with an embodiment of the present invention.

FIG. 6 shows a sequence of steps performed by a retail establishment in practicing an embodiment of the present invention.

FIG. 7 shows an embodiment of the present invention where a customer makes a payment to a third party by swiping a financial card through a magnetic card reader located in space personal to the customer and where the account number associated with the financial card does not need to be communicated to the payee.

Corresponding reference characters indicate corresponding structures and steps throughout the several views of the drawings.

### DETAILED DESCRIPTION OF PREFERRED EMBODIMENTS

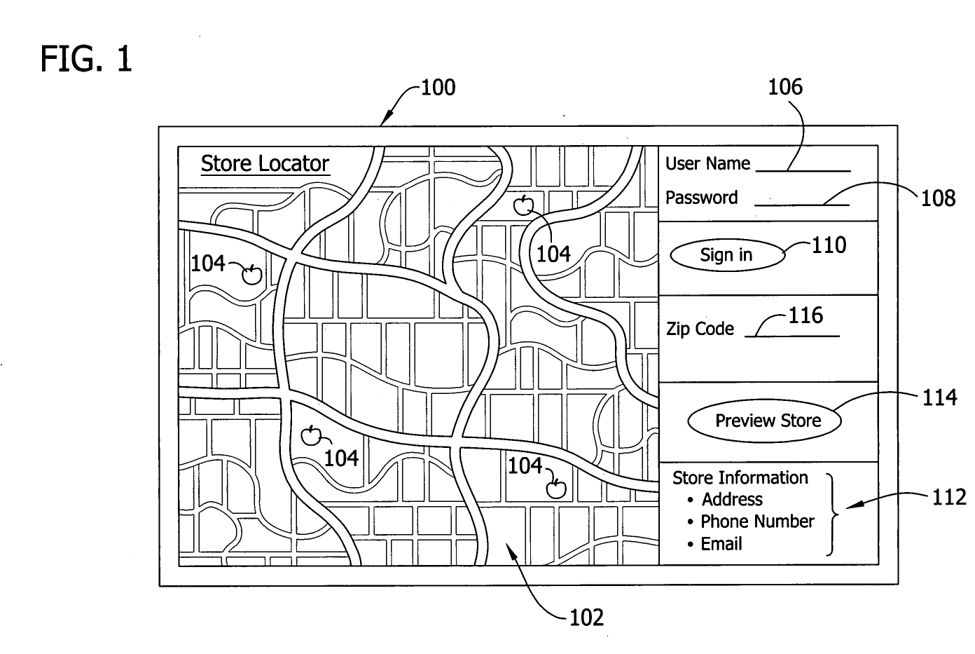

FIG. 1 shows a computer monitor 100 displaying a map 102 marked “Store Locator” of a geographic area where retail establishments practicing an embodiment of the present invention may be located. On the map 102, an icon such as the images of fresh apples 104 indicate the location on the map where a retail establishment practicing the present invention may be located. To the right of map 102 is an area where a customer can login by entering their name on line 106 and password on line 108. Any other suitable input graphic, such as the many forms known to those skilled in the art, may be used. After entering their name and password, the customer clicks on the sign in button 110 to complete the sign in process.

New customers looking for the closest location can click on one of the icons 104. The business address, telephone number and email address for the location will then appear on the computer screen in area 112. Clicking on a preview store button 114 provides further information about the store located at the address in area 112. This will also lead to computer screens, not shown, for enabling the new customer to set up an account accessible through an assigned user name and password.

Alternatively, a new customer can enter a zip code through input 116 and the address for the closest retail establishment practicing an embodiment of the present invention will appear in area 112.

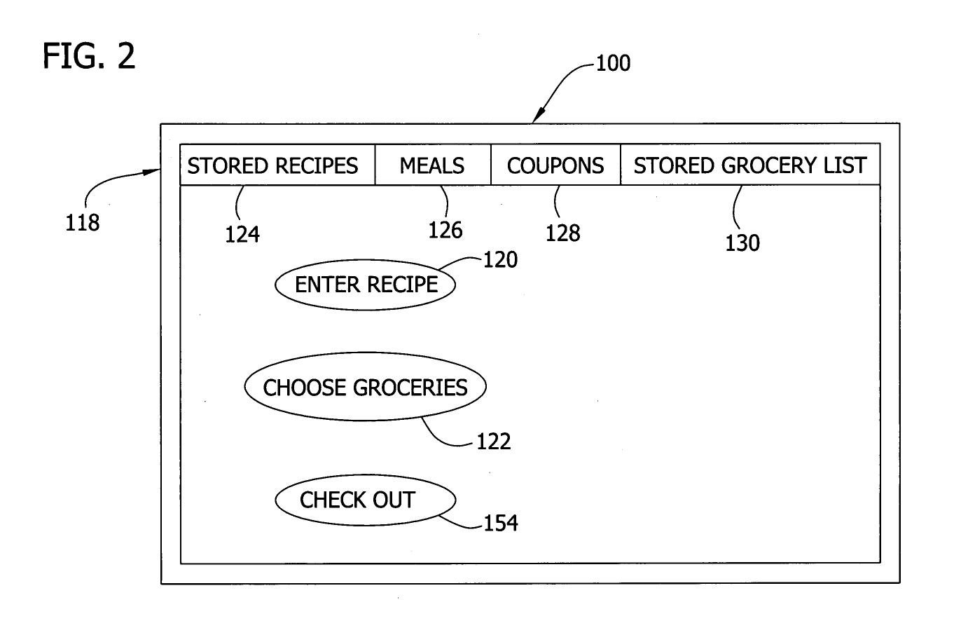

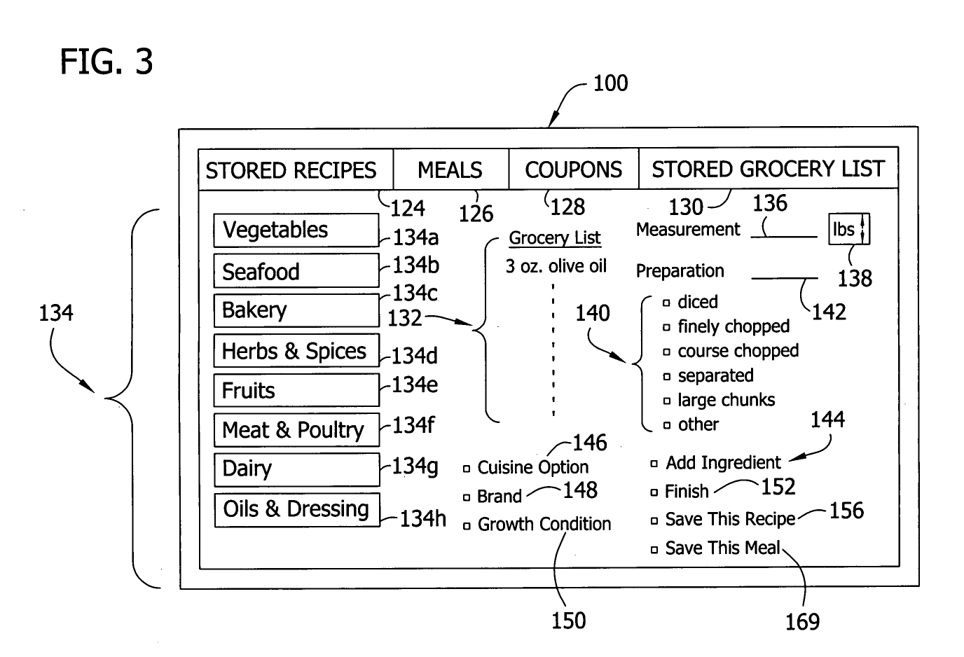

After logging in, FIG. 2 shows monitor 100 displaying a common header 118 as well as an “Enter Recipe” button 120 and a “Choose Groceries” button 122. As explained more fully below, particularly with regard to FIG. 3, clicking on the “Enter Recipe” button 120 enables the customer to input a brand new recipe which can be recalled during later shopping that day or perhaps weeks, months or even years later. Clicking on the “Choose Groceries” button 122 enables the customer to electronically preview the goods generally sold by the retail establishment and to add any such goods to the “Grocery List” (e.g., numeral 132 in FIG. 3) of goods to be purchased by the customer. The computer displays for implementing such general grocery shopping are well known to those skilled in the art and so will not be further discussed here.

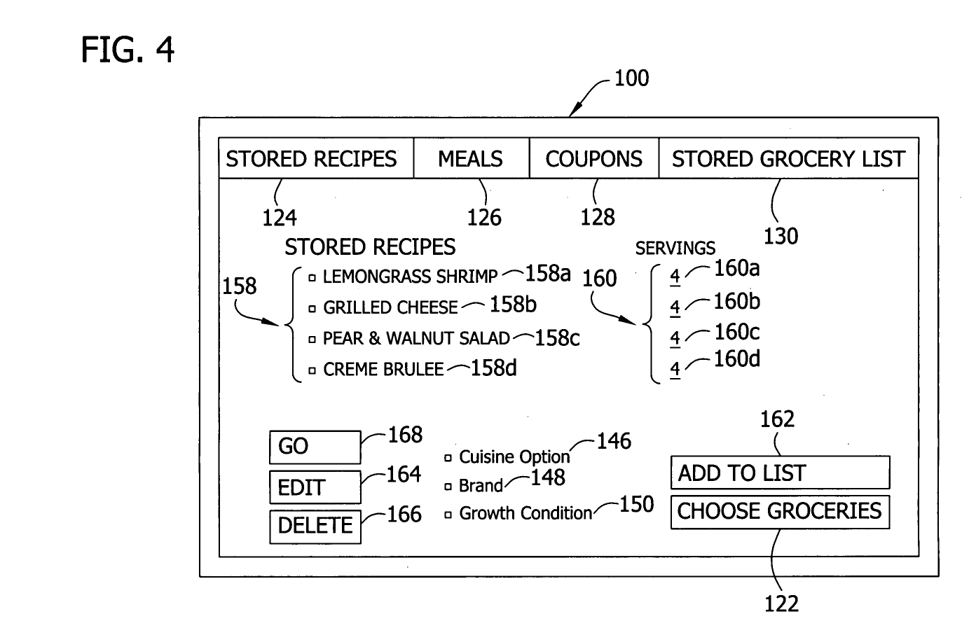

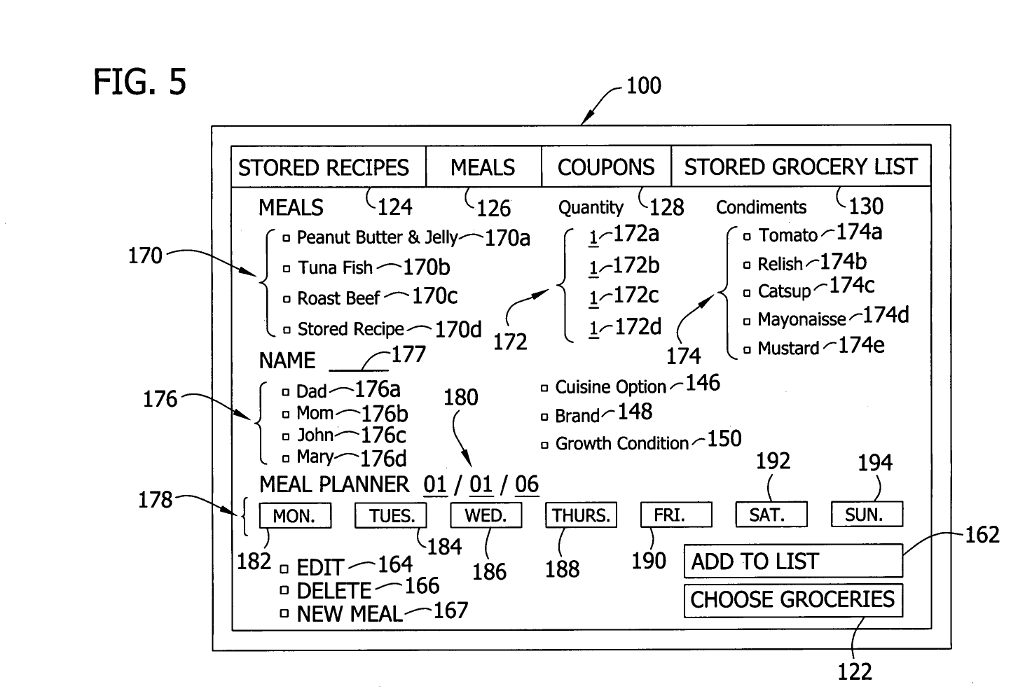

The buttons in header 118 provide further functionality. The Stored Recipes button 124, when clicked on, takes the customer to FIG. 4 where, as explained more fully below, the customer is allowed to shop “by recipe” by simply ordering all of the ingredients and their preparation for a previously stored recipe. The Stored Recipes button 124 also allows the customer to recall, edit or delete any previously stored recipes. The Meals button 126, when clicked on, takes the customer to FIG. 5 where, as explained more fully below, the customer is allowed to shop by simply ordering a previously stored meal or meal plan. The Meals button 126 also allows the customer to assemble a new meal plan or recall, edit or delete any previously stored meal plan.

The Coupons button 128, when clicked on, takes the customer to a series of screens, not shown, which display all of the available coupons then available for redemption at the retail establishment. The computer screens needed for displaying all of the available coupons are well known to those skilled in the art and so will not be further discussed here.

The Stored Grocery List button 130, when clicked on, recalls from memory all past grocery lists that have been saved. Through a series of screens, not shown, such past grocery lists are listed by name. The customer can simply reorder a past grocery list by clicking on the name of the grocery list. This saves time for products that are repetitively ordered from one week to the next.

FIG. 3 is displayed when the customer clicks the Enter Recipes button 120. FIG. 3 displays categories of ingredients through buttons 134a-134h down the left side in area 134. When a customer clicks on a button, for example Vegetable button 134a, area 134 preferably changes to display (not shown) a searchable, scrollable list of available vegetables in alphabetical order. A particular vegetable is then selected by clicking on its name. At the right hand side, the customer enters the amount of the vegetable on line 36 and the unit of measure through drop down box 138. Preparation instructions (e.g. diced onions) are entered through the instruction inputs in area 140. If the customer prefers a manner of preparation not listed in area 140, then written preparation instructions can be entered on line 142.

After the amount and preparation instructions for an ingredient have been entered, the customer clicks the “Add Ingredient” button 144 to add the ingredient to the Grocery List 132. Thus, a customer is able to shop for ingredients in customer specified amounts independent of the prepackaged amounts in which groceries are customarily sold. For example, the Grocery List 132 includes “3 oz. olive oil”—not a whole bottle of olive oil. Similarly, a dash of infrequently used spice can be ordered instead of purchasing an entire prepackaged amount that may go flat before the customer needs it again.

For some entries, such as Meat & Poultry button 134f, the customer may want to generically add a cuisine option, such as spicy chicken or cajun fish. Thus, when the chicken or fish ingredient is added to the recipe, the customer can click the Cuisine Option button 146 and a list of Cuisine Options (not shown) will appear. The list can include any cuisine option such as spicy, western, cajun, Mexican or Italian. When the customer thereafter clicks the add ingredient button 144 to add the chicken or fish to the grocery list 132, an appropriate amount of the relevant spices will also be added to the grocery list 132 as a function of the amount of the chicken or fish entered through box 138.

For customers who prefer a particular brand of ingredient, the Brand button 148 can be clicked. When the customer thereafter clicks the Add Ingredient button 144, a list of available brands (not shown) for the particular ingredient will appear. The customer can then select the desired brand. The Grocery List will then include that brand information for the ingredient.

For customers who prefer to specify particular growth or storage conditions for an ingredient, the Growth Condition button 150 can be clicked. When the customer thereafter clicks the Add Ingredient button 144, a list of available growth and storage conditions (not shown) for the particular ingredient will appear. For example, the customer may select free range chicken, antibiotic free beef, organically grown vegetables, vegetables grown without pesticides, or any of the many other types of information concerning growth or storage conditions that are available for ingredients. With the growing use of radio frequency identification tags and gps monitors on farms and in livestock operations, more and more growth and storage conditions are being tracked every day and will become available to the customer in making ingredient selections. After the customer selects the desired growth or storage condition, the Grocery List 132 will then include that condition information for the ingredient.

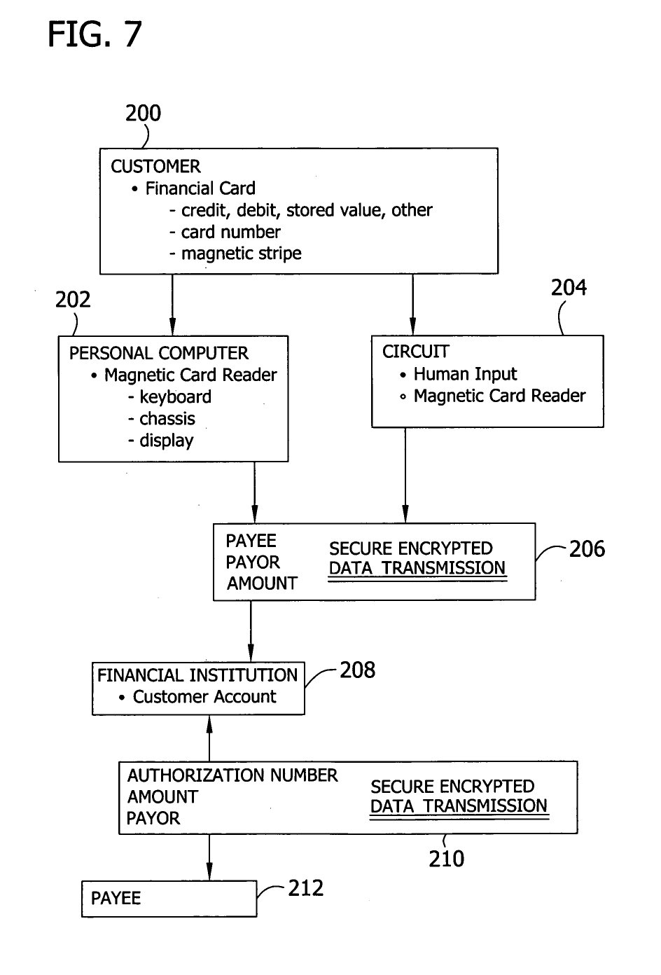

After all of the ingredients, amounts, preparation instructions and, if applicable, cuisine options, brands, growth and storage conditions have been entered for a recipe, the customer selects the Finish button 152 and the program returns to the display shown in FIG. 2. If the customer is done shopping, then the customer clicks the Checkout button 154 and the retail establishment processes and delivers the order per the operations set forth in FIG. 7. If the customer wishes to save the recipe for later shopping, then the customer clicks the Save This Recipe button in FIG. 3 and a screen (not shown) will appear to enable the customer to name the recipe and store it in a database for later retrieval and shopping. The customer will also enter the number of servings provided by the recipe. Thereafter, the program returns to the display shown in FIG. 2 where the customer can, again, checkout or, as explained more fully below, add individual groceries to the Grocery List 132 through button 122, add previously stored recipes to the Grocery List 132 through button 124, add previously organized meals to the Grocery List 132 through button 126 or add a previously stored grocery list to the Grocery List 132 through button 130.

The Choose Groceries button 122 works as follows. After being clicked, the program returns to the display shown in FIG. 3. The customer then selects a category of food through buttons 134. Again, upon being clicked, all of the available types of food in the selected category are displayed, preferably in alphabetical, scrollable order (not shown). When a type of food is thereafter selected, the customer again enters the amount on line 136 with an appropriate unit of measure through drop down box 138 and with an appropriate preparation instruction through the buttons in area 140 and input line 142. Again, the cuisine option 146, brand selection 148 and growth (or storage) conditions 150 can also be specified as explained above for entering a recipe. After each ingredient is thus specified, the customer clicks the Add Ingredient button 144 to add the specified ingredient to the Grocery List 132. After such shopping for individual groceries, the customer returns to the display shown in FIG. 2 to checkout out or continue shopping.

When the customer selects the Stored Recipes button 124, FIG. 4 is displayed. FIG. 4 includes the display of the names of previously stored recipes 158. For each of the displayed recipes, the corresponding number of servings is shown in area 160. For example, each of the recipes shown provides four servings. When the customer thereafter clicks the Add to List button 162, all of the ingredients for the selected recipe in the appropriate amounts are added to the Grocery List 132 in FIG. 3. If the customer changes the number of servings for a stored recipe by changing the number of servings in area 160, for example changes 4 servings to 2 servings in areas 160a after selecting Lemongrass Shrimp, then a relative proportion of the ingredients are added to the Grocery List 132. Here, one half of the ingredients would be added to the Grocery List 132.

If the customer wants to order a stored recipe but wants to vary the recipe with a cuisine option, then the customer selects the cuisine option button 146 before clicking the Add to List button 162. As with the operation of the display shown in FIG. 3, selection of the cuisine option button 146 will cause the display (not shown) of all of the available cuisine options. The ingredients required for the selected cuisine option will then be added to the Grocery List 132 along with the rest of the ingredients for the selected stored recipe when the customer thereafter selects the Add to List button 162.

If the customer wants to select the brands of the ingredients used in a selected stored recipe, then the customer selects the Brand button 148 before clicking the Add to List button 162. This will cause the display (not shown) of each ingredient in the selected stored recipe along with all of the available brands for the ingredient. This process can take the form of displaying the ingredients and available brands one ingredient at a time, or in groups of ingredients, at the preference of the customer or of the person implementing the present invention. After all of the brand selections, the customer can select the Add to List button 162 to add each of the ingredients by selected brand to the Grocery List 132.

If the customer wants to select the growth or storage conditions for the ingredients used in a selected stored recipe, then the customer selects the Growth Condition button 150 before clicking the Add to List button 162. This will cause the display (not shown) of each ingredient in the selected stored recipe along with all of the available growth and storage conditions for the ingredient. This process can take the form of displaying the ingredients and available growth and storage conditions one ingredient at a time, or in groups of ingredients, at the preference of the customer or of the person implementing the present invention. After all of the growth and storage condition selections, the customer can select the Add to List button 162 to add each of the ingredients by selected growth and storage condition to the Grocery List 132.

If the customer wishes to perform the cooking step for the recipe for greater freshness or otherwise, then the customer would not include final cooking instructions in the recipe delivered to the retail establishment. The uncooked or partially cooked ingredients would then be prepared to the point called for in the recipe and appropriately packaged and delivered to the customer per box 198 as more fully described below.

If the customer wants to edit a stored recipe 158, then the customer selects the particular recipe, for example Lemongrass Shrimp 158a, and also selects the Edit button 164. This causes the display (not shown) of each of the ingredients in the recipe which can be highlighted and deleted with a delete button in a conventional manner. Ingredients can also be added through an Add Ingredient button (not shown) which would then take the customer back through the display shown in FIG. 3 to add ingredients and preparation instructions.

When the customer is ready to checkout or move to another screen, the customer clicks the Go button 168 which takes the customer to the display in FIG. 2 for more shopping or to checkout, as described more fully above.

When the customer selects the Meals button 126 in, for example, FIG. 2, the program provides the display shown in FIG. 5. Area 170 displays the names of all of the meals which have been previously organized and stored in memory. Area 170 also includes access to the Stored Recipes through the Stored Recipe button 170d. When the number of stored meals exceeds the available display area, the program provides a conventional scrolling feature for displaying the names of the meals. The list can also be alphabetized with conventional sorting software.

In putting together a meal plan, the customer selects a meal such as a Roast Beef sandwich, 170c. The quantity of sandwiches can be changed through input 172c and condiments are selected as shown in area 174. As above, any meal can be modified with a cuisine selection through selection of the Cuisine Option button 146 which operates in the same manner as with FIGS. 3 and 4.

The customer can again control the brand of the ingredients used in making the meal by selecting the Brand button 148. Upon selection of the Brand button 148, each ingredient in the meal is displayed with the available brands (not shown) for selection by the customer as with the brand selections in FIGS. 3 and 4, above.

The customer can also control the growth and storage conditions for the ingredients used in making the meal by selecting the Growth Condition button 150. Upon selection of the Growth Condition button 150, each ingredient in the meal is displayed with the available growth and storage conditions (not shown) for selection by the customer as with the growth and storage condition selections in FIGS. 3 and 4, above.

The naming area 176 allows the customer to have a name label applied to the packaging for each meal. A new name can be added through input line 177.

After a meal has been composed and a name label identified, the customer can select one of the day buttons in area 178. For example, after a roast beef sandwich lunch is composed for John, the customer selects the Monday button 182 to have such a lunch packaged with John's name on it and, preferably, the day and date. Alternatively, the customer can drag the Roast Beef button 170c from area 170 and drop it on the Monday button 182. This process of “making lunches” or any other meal is repeated for each day and person needing a meal.

Sometimes a customer needs to make changes to a meal. This is done by selecting the meal name in area 170 and then selecting the Edit button 164. This causes the display (not shown) of each of the ingredients in the meal which can be highlighted and deleted with a delete button in a conventional manner. Ingredients can also be added through an Add Ingredient button (not shown) which would then take the customer back through the display shown in FIG. 3 to add ingredients and preparation instructions. A customer can delete a meal by selecting the meal name in area 170 and then selecting the Delete button 166.

New meals can be added to the stored meals displayed in area 170 by selecting the New Meal button 167. This takes the customer back to FIG. 3 where the new meal is composed in the same manner as the entry of a new recipe in FIG. 3. The only difference is that the process ends with the selection of the Save This Meal button 169 in FIG. 3.

New meals can also be added by selecting the Stored Recipe button 170d and then selecting the New Meal button 167. This opens a screen (not show) which lists the names of all of the stored recipes. The customer preferably highlights the stored recipes to be included in the meal and then selects a new meal button (not shown) to name the meal. The name of this new meal which includes each of the selected stored recipes will then appear in the Meals area 170 making the meal available to the customer during further shopping.

After the customer has put together a meal plan through FIG. 5, the customer selects the Add to List button 162 which enters all of the ingredients, preparations, and associated meal information on Grocery List 132 in FIG. 3.

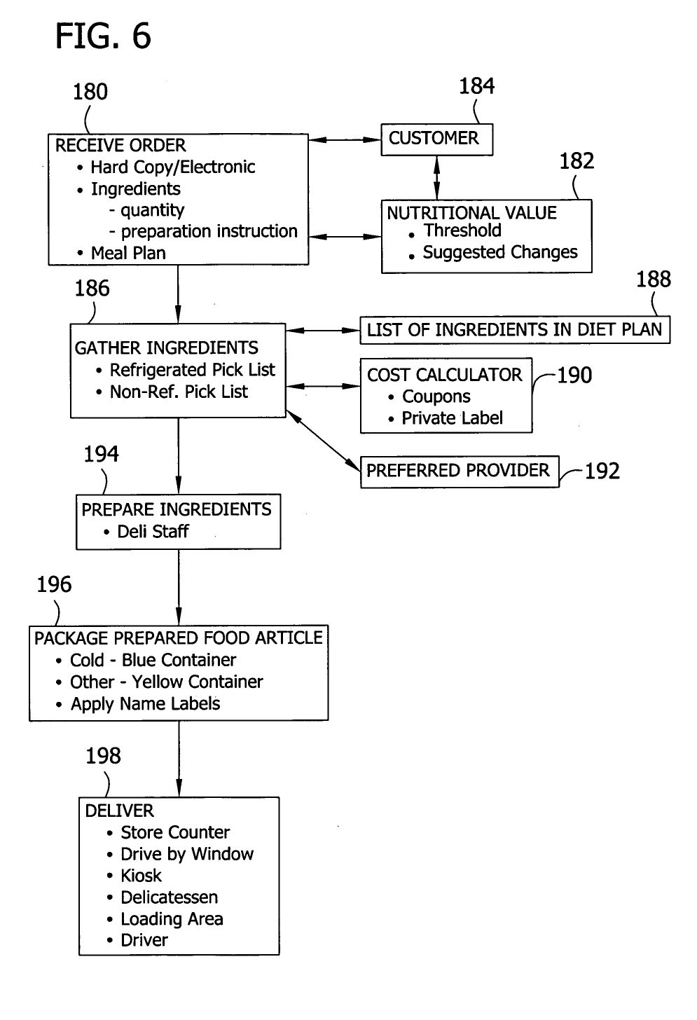

FIG. 6 shows the process used by the retail establishment for receiving an order from a customer, gathering the ingredients for the order, preparing the ingredients and then packaging and delivering the prepared food articles to the customer.

More particularly, after a customer selects the Checkout button 154 in FIG. 2, all of the ingredients, amounts, preparation instructions, packaging information and meal plan information comprising the customer's order are delivered to the retail establishment at box 180 in FIG. 6. This delivery of the customer's order to the retail establishment can occur in person, over the internet, through the mail, over the telephone, or through any other means of communication. Alternatively, a customer might want to order a recipe found in a recipe book, on the internet or from a friend. Such recipes would be provided to the retail establishment in box 180 in further practice of the invention. Preferably, orders are delivered in a fixed tangible medium such as being written or printed on paper, stored in a memory device, or being presented through an electronic transmission.

Box 182 shows a nutritional value calculator which can calculate the nutritional value of each meal, each recipe, each serving, a range of meals, a meal plan or any other subgroup of prepared food articles or groceries. As shown, this nutritional value may be communicated to the customer. The customer may have the option of revising the order in the event the nutritional value fails to meet the customer's expectations.

The nutritional value calculator in box 182 may also contain threshold information based on recommended daily allowances, nutrition information provided by a diet plan (such as the South Beach diet or the Atkin's diet), or nutrition information provided by the customer or a third party. The nutritional value calculator may also contain a database of ingredients with known nutritional values. Prior to communicating a nutritional value to a customer, the calculator can first compare the value against one of the stored thresholds and report to the customer whether the calculated nutritional value exceeds the threshold. The calculator can also use the ingredient database to provide the customer with suggested ingredient changes in the customer's order as a function of the threshold to make the calculated nutritional value meet or exceed the threshold. This can be done at the recipe level, the meal level, or even the meal plan level.

After an order has been received and is ready for preparation, an employee at the retail establishment, such as a grocery story, gathers the ingredients per box 186 in FIG. 6. To make the gathering easier and in order to separate refrigerated from non-refrigerated ingredients, separate refrigerated and non-refrigerated pick lists are preferably prepared. They can also be color-coded.

For customers who prefer to follow a diet plan, the gathering step includes consulting a list of ingredients approved under the diet plan in box 188 to preferentially select ingredients from that diet plan list. For customers who wish to reduce cost, a cost calculator in box 190 compares the list of ingredients for an order against all of the available coupons. The cost calculator then identifies the lowest cost ingredients to fill the order taking into effect the reduction in cost from any available coupons. The cost calculator can also be programmed to determine the lowest cost without regard to coupons. For customers who prefer private label ingredients, the cost calculator includes a list of private label ingredients and fills the order with such ingredients to the extent available.

The retail establishment can also set up preferred provider agreements as in box 192 to select preferred providers for a generic type of ingredient used in an order. When a customer states no preference for a particular brand, growth condition, storage condition, or cost of an ingredient, the retail establishment then selectively gathers ingredients originating with the preferred provider to fill an order. In this manner, the retail establishment can bargain to collect compensation from the preferred provider as a function of the provider's status as such.

After the ingredients for an order have been collected, employees of the retail establishment prepare the ingredients per the customer's instructions. As shown in box 194, when the retail establishment is a grocery store, it is preferable to use the delicatessen staff in the grocery store to prepare the ingredients.

Box 196 shows that the prepared food articles are packaged for delivery to the customer. Cold or refrigerated food articles are preferably packaged together. Color-coded packages such as blue packages for refrigerated food articles are preferably used. Other food articles can be packaged together in a different color package.

The packaging for meals, whether ordered separately or as part of a larger multi-person multi-day meal plan, preferably include separate labels for separate meals. And the labels preferably identify the name of the person for each meal, the day and date, and the type of meal.

Box 198 shows the delivery of the packaged prepared food articles to the customer. Preferably, the customer remembers their order number or prints off an invoice showing all of the prepared food articles and groceries in their order. A computer terminal may be made available at the retail establishment for customer use in printing such invoices.

The actual delivery to the customer in box 198 preferably occurs through a drive-by window or loading area. An area inside the retail establishment such as a store counter, kiosk or delicatessen area may also be used. For added convenience to the customer, a driver could also deliver the packaged prepared food article(s) to an address.

FIG. 7 shows an example of hardware which may be located in the customer's home, office or personal space for enabling the customer to make a secure payment for a purchase from a third party (such as the retail establishment in FIG. 6) using a financial card through an internet connection. As in box 200, the financial card can be a conventional credit card, debit card, stored value or other card having a magnetic strip on the back. Such cards typically have a card number identifying the customer's account against which the purchase will be charged.

Box 202 shows a conventional personal computer which includes a conventional magnetic card reader attached to the keyboard, chassis or display monitor of the personal computer. When the customer wishes to make a payment over the internet, the customer swipes the card through the magnetic card reader. Such swiping shows that the customer has physical possession of the card and does not simply know the card number. The personal computer is programmed to receive the data read during the swipe from the magnetic card reader. The personal computer then passes that card data as well as the amount of the transaction and the identity of the payee over the internet in box 206 to the financial institution responsible for the financial card in box 208. This data transmission shown by box 206 is preferably a secure, encrypted data transmission using security techniques known to those skilled in the art.

At box 208, the financial institution checks to make certain the customer's account has sufficient funds or a sufficient credit line before authorizing the transaction and charging the amount of the transaction against the customer's account. Once approved, the financial institution passes an authorization number for the transaction, the monetary amount approved, and the identity of the payor over the internet in box 210 to the payee (or the payee's bank) in box 212. The payee thus receives the appropriate monetary amount for the transaction with the security of an authorization number but without ever knowing the customer's account number or card number (if different). This data transmission shown by box 208 is preferably a secure, encrypted data transmission using security techniques known to those skilled in the art.

In practice, and as known by those skilled in the art, the function of the financial institution identified in box 208 is often implemented among several financial institutions. Often, a merchant clearing house will actually receive the data from the swiped financial card, as well as the data showing the amount of the transaction and the payee. The merchant clearing house may then pass such data to a cardholder bank so that the customer's credit line can be checked. An acquiring bank may then acquire and fund the transaction, including paying the payee's bank (or the payee directly) a sum corresponding to the transaction amount. Those skilled in the art will thus understand that the present invention may be practiced with a single financial institution or with multiple financial institutions—so long as the basic financial functions of authorizing and appropriately paying transactions without disclosing the customer's card or account number to the payee are accomplished.

Box 204 shows a simplified circuit for accomplishing the same transaction without the bulk or expense of a personal computer. Box 204 includes a circuit which can be coupled to the internet for communication over the internet. The circuit contains sufficient human input devices such as a mouse, keyboard, and/or touch-screen or the like, to allow for surfing the internet and making purchases. When the customer wishes to make a payment over the internet, the customer swipes the card through the magnetic card reader. The circuit is programmed to receive the data read during the swipe from the magnetic card reader. The circuit then passes that card data as well as the amount of the transaction and the identity of the payee over the internet in box 206 to the financial institution responsible for the financial card in box 208. The transaction then proceeds from there as described above.

Those skilled in the art will recognize that many different computer screens, graphics, display techniques and input techniques can be used in the practice of the present invention. The scope of the present invention is not limited to a particular software implementation. Further, the invention can be used with recipes obtained from others, obtained over the internet, obtained from a database maintained by the retail establishment which eventually prepares and sells the food article, or obtained from any other source by any other means. The computer displays shown in FIGS. 1-5 can be made available to the customer through a computer located at the retail establishment, through software provided to the customer over the internet or accessed through a web page, through software on the customer's computer, or by any other common computing means known to those skilled in the art for enabling the customer to use software.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

What is claimed is:

1. A method of preparing and selling an article of food from a retail establishment, the retail establishment having an inventory of ingredients in prepackaged amounts, the method comprising:
receiving an order from a customer;
wherein the order identifies a plurality of ingredients and a quantity for the ingredients, wherein the identified quantity for at least one of the ingredients is independent of the prepackaged amount, and wherein the order further includes a preparation instruction for at least one of the ingredients;
gathering the quantity of each of the ingredients from the inventory of the retail establishment as a function of the order;
preparing the ingredients at the retail establishment as a function of the preparation instruction to provide a prepared food article; and
packaging the prepared food article for available delivery to the customer.

2. The method of claim 1 wherein the order is a recipe.

3. The method of claim 1 further comprising:
consulting a list of potential ingredients corresponding to a diet plan; and
gathering the quantity of each of the ingredients from the inventory of the retail establishment as a function of the order and of the list.

4. The method of claim 1 further comprising:
calculating a nutritional value for the prepared food article; and
communicating the nutritional value to the customer.

5. The method of claim 4 further comprising:
setting a threshold for the nutritional value;
comparing the calculated nutritional value against the threshold; and
identifying a change of ingredients to the customer to make the calculated nutritional value meet the threshold.

6. The method of claim 1 further comprising:
preparing a first pick list for refrigerated ingredients; and
preparing a second pick list for non-refrigerated ingredients;
wherein the gathering step further comprises:
gathering the quantity of each of the ingredients on the first pick list from the inventory; and
gathering the quantity of each of the ingredients on the second pick list from the inventory;
wherein the packaging step further comprises:
packaging the refrigerated ingredients in a first color-coded container; and
packaging the non-refrigerated ingredients in a second color-coded container.

7. The method of claim 1 further comprising the step of delivering the prepared food article to the customer through a drive-by window or at a store counter.

8. The method of claim 1 further comprising:
enabling the customer to view a plurality of electronic images corresponding respectively to a plurality of orders; and
enabling the customer to drag and drop the electronic images into a file corresponding to a meal plan of orders spanning a predetermined period of time.

9. The method of claim 8 further comprising:
labeling packaged prepared food articles with a name.

10. The method of claim 8 further comprising:
calculating a nutritional value for the meal plan; and
communicating the nutritional value to the customer.

11. The method of claim 10 further comprising:
setting a threshold for the nutritional value;
comparing the calculated nutritional value against the threshold; and
identifying a change to the customer to enhance the nutritional value of the meal plan.

12. The method of claim 8 further comprising:
receiving the meal plan from the customer; and
preparing the ingredients as a function of the orders in the meal plan.

13. The method of claim 1 further comprising:
enabling the customer to select a cuisine option; and
preparing the ingredients as a function of the order and of the selected cuisine option.

14. The method of claim 1 further comprising:
selecting a preferred provider for a generic type of ingredient used in an order;
selectively gathering ingredients originating with the preferred provided unless the customer specifies a different source for the ingredients; and
collecting compensation from the preferred provider as a function of said provider's status as the preferred provider.

15. The method of claim 1 further comprising:
calculating a cost of the ingredients required for the order; and
gathering the ingredients used in preparing the food article to reduce the cost as a function of a price for the ingredients.

16. The method of claim 1 further comprising:
identifying a food coupon corresponding to an ingredient in the order;
calculating a cost of the ingredients required for the order reduced by any identified coupons; and
gathering the ingredients used in preparing the food article to reduce the cost as a function of a price for the ingredients discounted by any identified food coupons.

17. The method of claim 1 further comprising:
enabling the customer to specify an ingredient for the order based on a brand or source of the ingredient.

18. The method of claim 1 further comprising:
enabling the customer to specify an ingredient for the order based on a growth or storage condition of the ingredient.

19. The method of claim 1 further comprising:
enabling the customer to purchase the prepared food article on a same invoice as a prepackaged item sold at the retail establishment.

20. The method of claim 1 wherein the retail establishment further comprises a delicatessen staffed by an employee and wherein the method further comprises utilizing the employee to prepare the ingredients as a function of the preparation instruction.

21. A method of preparing and selling an article of food from a retail establishment, the method comprising:
receiving an order from a retail customer over an internet connection;
wherein the order identifies a plurality of ingredients and a quantity for the ingredients, and wherein the order further includes a preparation instruction;
gathering the quantity of each of the ingredients as a function of the order;
preparing the ingredients at the retail establishment as a function of the preparation instruction to provide a prepared food article; and
packaging the prepared food article for delivery to the retail customer.

22. The method of claim 21 wherein the retail customer holds a financial card from a financial institution and wherein the financial card bears a card number identifying an account for the retail customer with the financial institution, the method further comprising:
receiving an authorization number from the financial institution via the internet connection in lieu of receiving the card number from the retail customer in order to validate the retail customer's purchase of the prepared food article;
wherein a monetary amount corresponding to the purchase is electronically charged against the retail customer's account.

23. The method of claim 21 further comprising:
calculating a nutritional value for the prepared food article; and
communicating the nutritional value to the customer.

24. The method of claim 21 further comprising:
identifying a food coupon corresponding to an ingredient in the order;
calculating a cost of the ingredients required for the order; and
gathering the ingredients used in preparing the food article to reduce the cost as a function of a price for the ingredients discounted by the identified food coupon.

25. The method of claim 21 further comprising:
enabling the customer to specify an ingredient for the order based on a brand or source of the ingredient.

26. The method of claim 21 further comprising:
enabling the customer to specify an ingredient for the order based on a growth or storage condition of the ingredient.

27. An apparatus for enabling a retail customer to make a payment for a purchase from a third party using a financial card through an internet connection, the purchase to be charged against an account held by the retail customer with a financial institution, the apparatus comprising:
a magnetic card reader located in the retail customer's home, office or personal space for enabling the retail customer to swipe the financial card through the magnetic card reader, wherein the magnetic card reader is adapted to read customer information upon the occurrence of the card being swiped;
a circuit coupled to the magnetic card reader and the internet connection for transmitting the following to the financial institution over the internet: the customer information, data corresponding to the third party and a monetary amount corresponding to the purchase;
whereby the monetary amount corresponding to the purchase may be charged against the account.

28. The apparatus of claim 27 wherein the circuit comprises a personal computer and wherein the magnetic card reader is physically attached to a keyboard, chassis or display of the personal computer.
